(19) United States
(12) Patent Application Publication
(10) Pub. No.: US 2006/0277488 A1
(43) Pub. Date: Dec. 7, 2006

(54) Information presentation on wide-screen displays

(75) Inventors: Ronald S. Cok, Rochester, NY (US); Michael E. Miller, Honeoye Falls, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/146,850

(22) Filed: Jun. 7, 2005

(51) Int. Cl. G06F 9/00

(52) U.S. Cl. 715/784

(57) ABSTRACT

A graphic user interface optimized for the presentation of information from a file on a wide-screen display comprising: a) a windowed display having at least first and second information presentation sections for concurrently displaying portions of sequential information from the file; and b) a scroll mechanism associated with each information presentation section, and a locking mechanism for associating one information presentation section with an other information presentation section, wherein when activated, the locking mechanism causes the associated information presentation sections to scroll in common, and when not activated, the locking mechanism allows the associated information sections to scroll independently.

### FIELD OF THE INVENTION

The present invention relates to user interfaces for information interaction and, more particularly, to graphic user interfaces for wide-screen displays.

### BACKGROUND OF THE INVENTION

Information display device devices are well known and used for a wide variety of applications for which information, and user interaction with information, are critical. Monitors associated with computers are a typical and widely used example. A typical monitor has a standard aspect ratio of approximately 4:3 and is slightly wider than it is high when viewed by a user seated or standing in front of the monitor. Many modern computers are capable of driving such monitors at a variety of pixel resolutions, for example 800 by 600, 1280 by 1024, 1600 by 1200 and 1920 by 1200.

Graphic user interfaces (GUIs) are the conventional means for interacting with, and controlling, a computer at present. The graphic user interface is typically controlled by the computer's operating system and provides means for organizing files, running application software, for example text editors, spreadsheets, and presentation software for presenting information to groups of people. The application software typically employs related graphic elements, for example, windows, panes, buttons, tool bars, menus, scroll bars, and the like, as are commonly found in graphic user interfaces today. The graphic elements are operated through a computer mouse or through special keyboard key combinations, known as keyboard shortcuts. In particular, windows are graphic objects within which application software user interfaces are presented. Such windows may be opened, closed, moved, and resized in a display. Within a window, graphic elements may be presented; typically such graphic elements present status information and allow the operator to apply operations on information manipulated by the application. In a typical prior-art user interface one set of graphic controls are associated with each window.

Within some application windows, panes may be employed to present information. Multiple panes may be used to present multiple views of information from one or more files. Panes may have associated controls whose operations are limited to the information presented in the panes. In particular, scroll bars may be employed to present a portion of the information in a file of sequentially organized information, for example a text file or presentation file.

Given the plethora of information presented to users of computing devices, it is important that the displays be efficiently used so as to present as much useful information as possible while maintaining clarity and ease of use when interacting with the presented information. For example, U.S. Pat. No. 6,724,403 B1 and US20030020671 A1 both entitled “System and method for simultaneous display of multiple information sources” describe a computerized method of presenting information from a variety of sources on a display device. Specifically the invention describes a graphic user interface for organizing the simultaneous display of information from a multitude of information sources using a tile structure. Likewise, U.S. Pat. No. 6,725,427 B2 entitled “Document stream operating system with document organizing and display facilities” discloses a document stream operating system and method in which: (1) documents are stored in one or more chronologically ordered streams; (2) the location and nature of file storage is transparent to the user; (3) information is organized as needed instead of at the time the document is created; (4) sophisticated logic is provided for summarizing a large group of related documents at the time a user wants a concise overview; and (5) archiving is automatic. The documents can include text, pictures, animations, software programs or any other type of data.

A variety of applications can be considered in presenting useful information to a user in efficient ways. US20030137522 A1 entitled “Innovations for the display of web pages” describes the use of a simultaneous overview and magnified views of a web page. Similarly, EP1215570 A1 entitled “Providing a windows-based user interface” describes a method for providing a windows-based user interface adapted to provide a plurality of windows for executing application programs and for user interaction controls displayable by an external browser. Tools may also be provided for moving between applications in a multi-threaded computer operating system. For example, US20020149615 A1 entitled “Navigation tool for accessing workspaces and modules in a graphic user interface” describes a method and system for displaying information related to a plurality of resources in a network environment.

In typical prior-art presentation software applications, a single window with scroll bars may be employed for presenting portions of sequential information from a file. In some applications, windows may be horizontally split into two or more separate panes. The information presented within the panes may be the same or related information so that if the information is modified, by editing, for example, the change in information may be shown in both panes. It is also known to provide separate windows that present the same information, or different portions of the same information. It is also possible to provide a separate copy of information in a separate window, and to modify the information in the separate copy. However, in this case, any modifications made on one copy are not present in other copies and not shown in any other windows presenting the information from the other copies.

As shown in the prior-art illustration of FIG. 2, textual information (for example, text documents, spreadsheet documents, and presentation documents) is conventionally presented in a pane within a window and multiple views of portions of a single text file of sequential information may be provided. Referring to FIG. 2, a conventional format display 10 has a single windowed interface 12 in an application for editing a text file. Text 15 is shown in a pane 14. Vertical scroll bars 20 with sliders 30 are used to change the portion of the text file presented in the pane; by operating the scroll bar controls the portion of text in the file presented may be moved forward or backward. A horizontal scroll bar 22 is used to change the view of the portion of lines of text from the left to the right. FIG. 3, illustrates multiple views of the text in separate panes 14a and 14b of a single window 12. Information may also be presented in the form of multiple columns 16 within a single pane 14 of a window 12 as illustrated in FIG. 4.

While these innovations are useful in optimizing the utility of a windowed user interface for information presentation and application control, they are still limited by the resolution and the size of the display on which the information and applications are presented. By expanding the resolution and size of an interactive display, increased screen space may be provided. For example, US20040239890 A1 entitled “Curved-screen immersive rear projection display” describes a rear projection display capable of providing aspect ratios of 2.66:1 or 4:1, or even greater. This allows viewers to be “immersed” in the images being displayed because the images can encompass both the direct and the peripheral views of a viewer. More importantly when interacting with traditional desktop applications, such a display allows the user to view multiple pages at a time, allowing user's to view significantly larger portions of the documents or information they are manipulating. In one implementation, the immersive rear-projection display includes two or more electronic projectors (e.g., three) that are positioned behind a curved translucent display screen. The electronic projectors project respective display images adjacent to each other onto the display screen. Regardless of the technology employed to present information in a wide-screen format (i.e., formats having an aspect ratio of greater than 4:3), this approach can provide additional horizontal resolution in a monitor that can be employed to display additional information.

However, prior-art windowed graphic user interfaces are not optimized for efficient use and navigation within a wide-screen display. In particular, multiple panes of sequential information are not easily shown and manipulated in common, for example a sequence of pages. Particularly it is known that when editing large documents, spreadsheets or other information source, it is often important for a user to refer to one or more portions of the information source while interacting with another, non-contiguous portion of the information source. To illustrate this point using the specific example of a patent application, it may be particularly useful to view the background, a portion of the preferred embodiment, and the first claim simultaneously. It is also important that once a user establishes a particular view of a document that it be possible to retain and return to this view. Finally, for individuals using documents that have a common format, it would be useful to apply this same view to other documents, which have this common format.

There is a need therefore for an improved user interface design for information presentation and interaction on a wide-screen display.

### SUMMARY OF THE INVENTION

In accordance with one embodiment, the present invention is directed towards a graphic user interface optimized for the presentation of information from a file on a wide-screen display comprising:

a) a windowed display having at least first and second information presentation sections for concurrently displaying portions of sequential information from the file; and

b) a scroll mechanism associated with each information presentation section, and a locking mechanism for associating one information presentation section with an other information presentation section, wherein when activated, the locking mechanism causes the associated information presentation sections to scroll in common, and when not activated, the locking mechanism allows the associated information sections to scroll independently.

### ADVANTAGES

The present invention has the advantage that it provides improved efficiency for user interaction with data in a wide-screen format.

### BRIEF DESCRIPTION OF THE DRAWINGS

FIG. 1 is a depiction of a graphic user interface having three presentation sections and a wide-screen display according to one embodiment of the present invention;

FIG. 2 is a depiction of a prior-art graphic user interface window on a conventional monitor with a 4:3 aspect ratio;

FIG. 3 is a depiction of a prior-art graphic user interface window with multiple panes;

FIG. 4 is a depiction of a prior-art graphic user interface window with multiple columns;

FIG. 5 is a depiction of a graphic user interface having three docked presentation sections according to another embodiment of the present invention; and

FIG. 6 is a depiction of a graphic user interface having three presentation sections according to an alternative embodiment of the present invention.

### DETAILED DESCRIPTION OF THE INVENTION

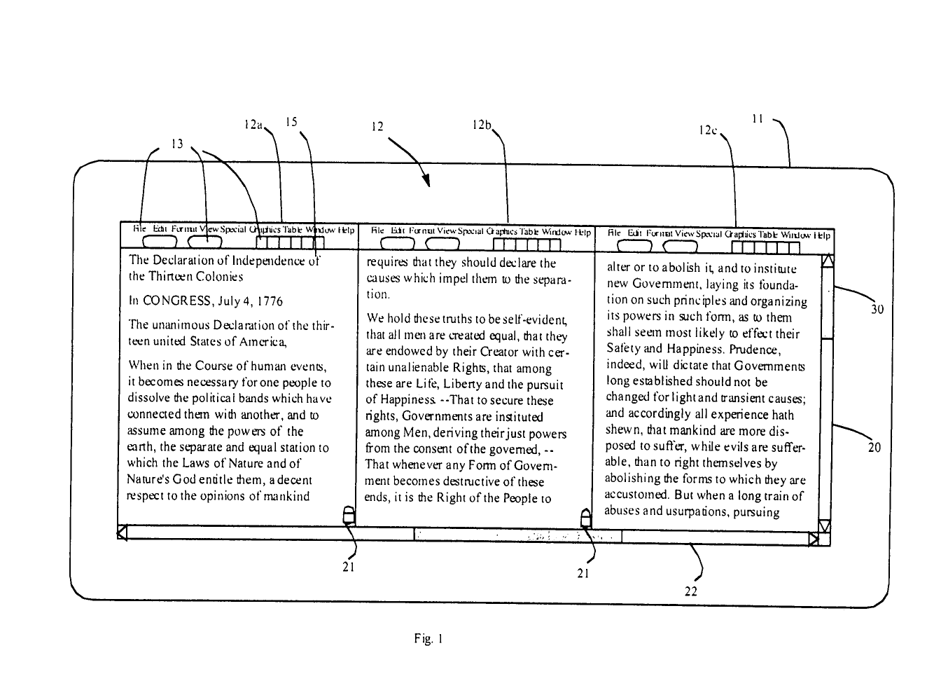

Referring to FIG. 1, a graphic user interface in accordance with one embodiment of the invention optimized for the presentation of information from a file on a wide-screen display 11 comprises: a windowed display 12 having first, second and third information presentation sections 12a, 12b and 12c for concurrently displaying portions of sequential information 15 from the file; and a scroll mechanism (20, 22) associated with each information presentation section 12a, 12b, 12c. The graphic user interface further includes a locking mechanism (21, 23) for associating each information presentation section 12a, 12b and 12c with one or more other information presentation section 12a, 12b and 12c, wherein when activated, the locking mechanism causes the associated information presentation sections to scroll in common, and when not activated, the locking mechanism allows the associated information sections to scroll independently.

Each presentation section may be individually locked or unlocked with respect to any other presentation section. It is convenient to represent the locking status of each presentation section with an icon so that a user will readily understand the state of each presentation section. For example, as shown in FIG. 1, the locking mechanism state for presentation sections 12a and 12b is illustrated with a locked icon 21 in the presentation section position conventionally occupied by a scroll bar 20. When unlocked, the locking mechanism state may be illustrated by absence of the icon 21 and with an added conventional scroll bar 20 in its place. By interacting with the locked icon 21 (for example by selecting it with a pointing device such as a computer mouse), the locked icon 21 may be converted to a scroll bar 20. By interacting with the scroll bar 20 (for example by shift clicking on it with a pointing device such as a mouse), the scroll bar 20 may be converted to a locked icon 21.

In another alternative embodiment, illustrated in FIG. 5, each presentation section may continuously display a scroll bar 20, and may further include a locked icon 21 when it is in the locked state and an unlocked icon 23 when it is in the unlocked state. By interacting with the locked icon 21 (for example by selecting it with a pointing device such as a mouse), the locked icon 21 is converted to an unlocked icon 23 and the state of the presentation section changed from a locked scrolling state to an unlocked scrolling state and vice versa. Within this embodiment, the scroll bar for a particular presentation section may be dimmed when the icon is in the locked state, indicating that the scroll bar is inactive and that the user must use another scroll bar to scroll the window. Alternatively, the scroll bar could remain active, but control all of the contiguous presentation sections that are locked together.

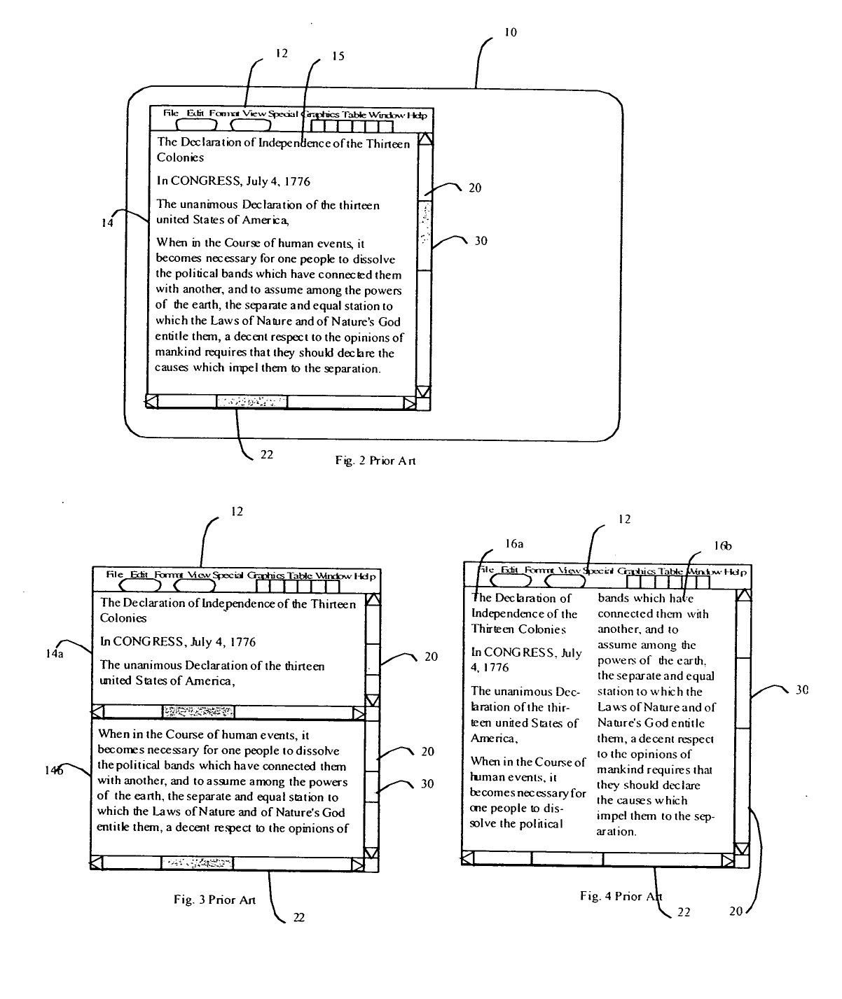

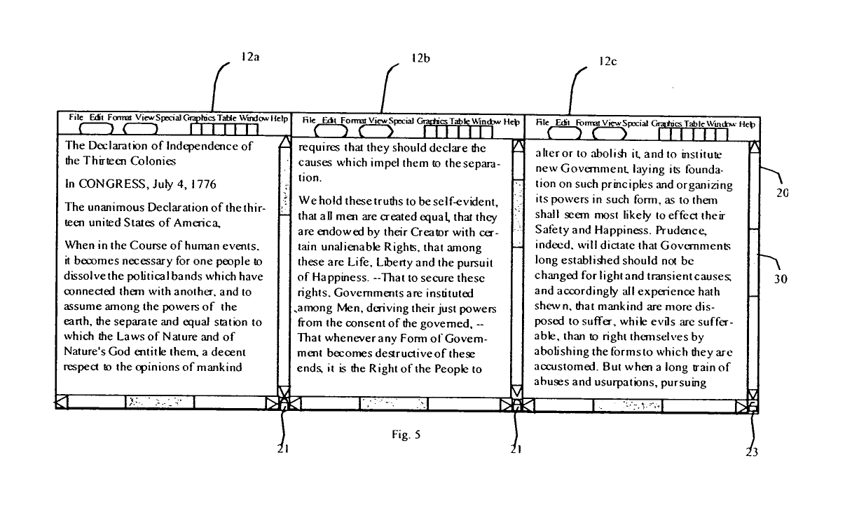

In another embodiment, multiple, conventional windows such as those shown in FIG. 2 may be spawned, and a software window docking mechanism may be employed to associate the separately spawned windows. When these windows are each displayed as individual windows, the scrolling behavior of one window does not affect the scrolling behavior of another. However, by selecting one of the windows with the cursor and dragging this window such that the left edge of the window, overlaps the right edge of a second window and releasing the window in this location, the two windows may be docked and automatically locked together as might be shown in FIG. 1 in the case that three such windows have been docked. In this state, the available scrolling mechanisms scroll the information together. If the user then decides to scroll the information separately, clicking the mouse over the locked button will allow the panes to separate into multiple windows, or to unlock as in the first described embodiment. For example, clicking the lock icon in the right-most window may allow the windows to be separated such that the left two panes remain connected together within one window while the right-most pane is recreated within a separate window, which may be scrolled independently of the two left-most panes. Within such an interface, one or more additional associated presentation sections may be created by increasing the window size of one presentation section. For example, the user may also create multiple windows by first extending the horizontal dimension of one window such that multiple panes are shown as in FIG. 1. Simply clicking on one of the locked icons then spawns individual windows.

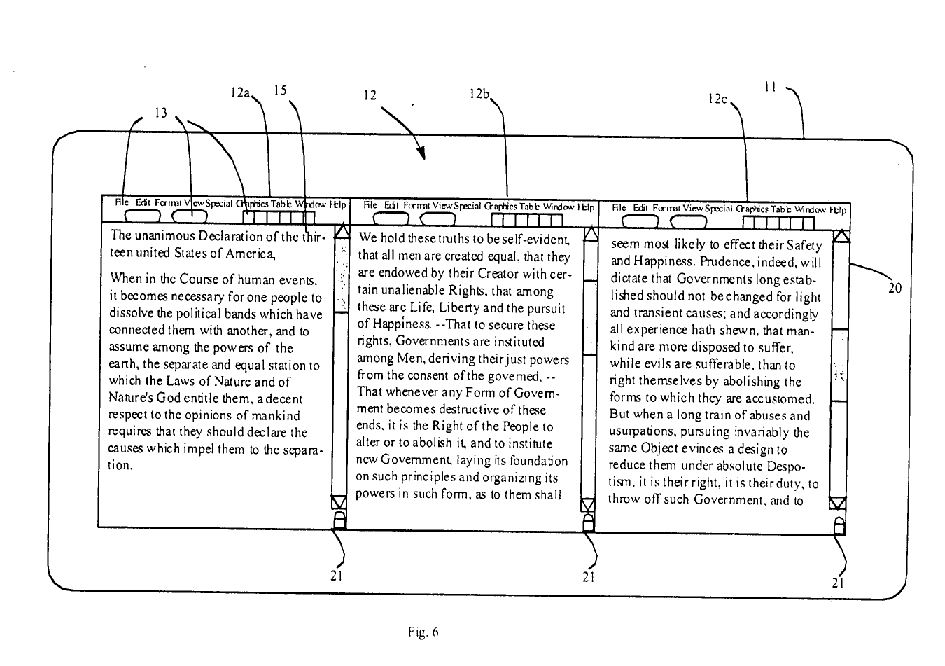

According to the present invention, a scroll mechanism is associated with each information presentation section 12a, 12b, 12c that, when locked, causes the associated information presentation to scroll in common with another information presentation section and, when unlocked, allows the associated information section to scroll independently of another information presentation section. Hence, if a scrolling mechanism is unlocked and a vertical scrolling icon 20 using a conventional set of scroll bar icons is employed to change the portion of sequential information displayed, as the scroll icon is manipulated, the portions of information in the associated information presentation section only is changed. Alternatively, a horizontal scroll bar 22 could be used. The scroll bars may be located at the top, bottom, or either side of a presentation section or of a group of presentation sections. This operation is conventional. If the scrolling mechanisms for a group of presentation sections are locked, however, a single, common scroll icon may be employed to provide the scrolling mechanism for all of the locked presentation sections. In such case, the activation of the scroll bar will affect the portions of information shown in every presentation section in the locked group. That is, all of the sections are scrolled together. If a plurality of scroll bar icons are employed in a locked group of presentation sections, for example one scroll bar icon for each presentation section (as shown in FIGS. 5 and 6), manipulating any one of the scroll bar icons will affect all of the portions of information displayed in the presentation sections, as well as the other scroll bar icons. In this case, as the scroll bar icon associated with the other second presentation section is manipulated, the portion of sequential information displayed will change in both the first and second presentation sections, just as if a scroll bar in each presentation section had been identically manipulated. In an alternative embodiment, if a scroll bar icon is displayed with the first presentation section, the scroll bar icon in the first presentation section may be manipulated and the portion of sequential information displayed will change in both the first and second presentation sections, just as if a scroll bar in each presentation section had been identically manipulated. In short, when a scrolling mechanism in a presentation section is locked with another presentation section, manipulating a scroll bar icon in either presentation section will scroll both presentation sections.

As is conventional, the size and position of a slider 30 in a scroll bar may indicate the position and relative quantity of the information displayed in the section. Hence, in the embodiments of FIGS. 5 and 6, where a separate vertical scroll bar is used for each locked presentation section, moving any one vertical slider 30 will result in all of the vertical sliders 30 moving in concert and all of the portions of information displayed in each presentation section likewise changing in concert. Likewise, if information is added or deleted to the file, the relative sizes of each slider 30 in each scroll bar may change.

When locking a presentation section to another in a display having two presentation sections, locking either presentation section will automatically associate it with the other presentation section. However, if more than two unlocked presentation sections are present, a locked presentation section must be associated with one of a plurality of other presentation sections. In this case, an arbitrary choice may be made by a user or a default association employed, for example the selected presentation section may be locked to the first or last other presentation section created by the user, or the selected presentation section may be locked to the presentation section displaying information nearest to that which it displays. In another example, the locking mechanism may lock or unlock a section with respect to the window directly to the left of the selected section. In this case, the left-most pane would not be required to have a locking mechanism. Other default associations are possible, as are means for allowing a user to select an association. Presentation sections can be locked to larger groups of locked presentation sections, for example three windows may be locked together (as illustrated in FIG. 1). All of the presentation sections locked together are scrolled together. It should be noted that within certain interfaces it may be desirable that locked presentation sections be contiguous, although this is not necessary.

The presentation sections may be individually positioned within separate windows, each with a separate set of controls. Alternatively, the presentation sections may be located within separate panes of a single, common window.

The information presented by the separate presentation sections may be continuous, may overlap, or may be discontinuous. For example, as illustrated in FIG. 1, each presentation section shows text that flows from one section to the other without omitting any of the sequential information. Thus, the presentation sections show a continuous flow of sequential information. If the sections showed portions of the same text, the presentation sections would overlap. If portions of the text between the portions presented in two of the presentation sections are not displayed, the presentation sections are discontinuous.

When performing the locking step within any of the interfaces, the information within each of the sections may not be continuous. Therefore, when locking two or more sections together, it is unclear whether the user wishes to lock the information together such that it is continuous and, if so, which section's information should be adjusted. One approach to this issue is to set a default, such as the information in the left-most of the two sections to be locked together will remain stationary while the information in the second section will be automatically scrolled such that the information it contains directly follows the information in the left section. Another approach would be to provide the user a dialog box asking how the information within the two sections should be configured. Such a dialog box might include options for allowing the information to be discontinuous or continuous and if continuous allowing the user to select the section whose information remains stationary.

A user may interact with the information shown in any of the presentation sections as is done in conventional graphic windowed interfaces for sequential organized information such as text. As with most desktop publishing software applications, if any change is made to the text, it can be modified in the display to illustrate the change in the text so that the information presented to the user will be consistent within each window or pane, that is, allowing the user to see the same information as shown on the display when the information is printed (WYSIWYG). However, the present invention is not limited to desktop publishing applications such as are illustrated in FIG. 1. The present invention may by employed in editing any files of sequentially organized information, including those found in spreadsheets and in presentation files used for projection to an audience. Changes made to the content or layout of any of the information will be reflected in any presentation section presenting a portion of the information whose content or layout has been modified as a consequence of the change. For example, such changes may include character substitution, addition, or deletion, or formatting changes in layout such as margins and pagination.

The separate presentation sections may be contiguously docked together and manipulated as a group. The sections may be of different sizes, or may be of a single uniform size. Groups of docked presentation sections may be aligned and positioned so that they are touching on whatever side the presentation sections are docked, either horizontally or vertically. Alternatively, the presentation sections may be manipulated separately. As shown in FIGS. 1, 5, and 6, the three presentation sections 12a-c are arranged horizontally. Docking provides a useful way of efficiently handling a plurality of presentation sections as a group.

The controls 13 employed by an application are conventionally arranged around the periphery, primarily but not exclusively, at the top of the presentation window. These controls 13 may include, for example, buttons, tool bars, menus, graphic elements, and text elements that, when operated, perform operations on the information or the presentation of the information. Other controls such as scroll bars, affect the portion of information viewed, rather than the information content or layout. These controls may be replicated in each presentation section or a single set of controls may be provided.

As a simple example, consider a sequential text file with conventional words arranged in sentences and paragraphs to form a multi-page document, as shown in FIG. 1. For the purposes of this example, presume that the sequential information displayed in each presentation sections is continuous and shows a different, non-overlapping portion of the sequential information and that the three presentation sections illustrated are locked, as shown with the locking icons 21. If one paragraph is removed from the text displayed in one presentation section, the presentation section that displays that paragraph will remove the paragraph from the display and move the text following the excised paragraph up to follow the text just before the excised paragraph. Any other presentation section displaying text that follows the excised paragraph will also have its text moved up in the display. Referring back to FIG. 1, the text in the three presentation sections 12a, 12b, and 12c display a continuous and non-overlapping portion of the information without omissions. If one paragraph in presentation section 12a were deleted, the view of the sequential information displayed in presentation sections 12b and 12c would likewise change. Referring to FIG. 6, the first paragraph has been deleted and the text is correspondingly moved up in each of the three presentation sections 12a, 12b, and 12c. If the sections are not continuous, such that portions of the text between the portions presented in two of the presentation sections are not displayed, changes to information displayed in one section may still result in changes to the portion of information displayed in another section, as format and relative position of the portions of displayed information will be maintained since the presentation sections are locked. FIG. 6 also illustrates a separate scroll icon associated with each presentation section. If the presentation sections are unlocked, editing changes in one presentation section may not affect the position of the information in other presentation sections, especially if the information presented is discontinuous.

Although, according to various embodiments of the present invention, the presentation sections may be independently located on a display screen, it may be useful to dock the sections together in a physically ordered arrangement that corresponds to the sequential order of the sequential information portions displayed in the presentation sections. For example, as shown in FIGS. 1,5, and 6, the presentation sections are docked horizontally and locked so that the presentation sections show a continuous flow of information from one presentation section to the next in the order shown from left to right. If each presentation section were to show a page of the information, the sequential pages would be displayed from left to right.

Both vertical and horizontal scroll bars may be employed, as shown in FIGS. 5 and 6. In one embodiment, a horizontal scroll bar may be associated with each presentation section in a locked group and used to locate text on a page, as is done conventionally. In such embodiment, the horizontal scroll bars may be controlled by a common scrolling mechanism or may not. Alternatively, a single horizontal scroll bar may be employed to commonly locate text on a page for all presentation sections (FIG. 1). In an alternative embodiment, a single or multiple horizontal scroll bars may be used to locate the portion views of the presentation sections using a common scrolling mechanism. In this latter case, it may be preferred not to employ vertical scroll bars.

The presentation sections of the present invention may be resized as is done with conventional window displays. Software for the graphic user interface of the invention may be programmed to account for user preferences when performing resizing operations. A group of presentation sections may be resized as a group or alternatively may be individually resized.

It may be useful to store the window configuration with the document when an editing session is complete. In the event that the same or different user accesses the same document on a computer having a display capable of displaying the window configuration, this same window configuration should be restored when the document is accessed for further editing. It may be noted, however, that if the document is accessed on a computer having a display that does not have sufficient size to display the entire window configuration, the windows may be reconfigured to fit the size of the display.

Software employing this invention may also enable macros for automatically configuring different types of documents to be automatically displayed with a given windows configuration. For example, when editing a word document, the user may select a menu option such as “Make Default View” or “Make Default Document View”. Selecting the former of these menu selections will allow any further documents that are opened to be viewed with the window and locking mechanism structure as the document they are currently editing. That is, if the user has two independently scrollable panes within a window, any future documents will be opened with this same view.

Custom views may also be created for different types of documents. In one example, when the user selects “Make Default Document View”, the software application may automatically store not only the window structure but the first section heading that appears within each unlocked pane as a definition of the default document view. When opening a new document, it is determined if the new document is of the same type as the document that was being edited when the default document view was stored. This determination may be made based on metadata or through other means such as determining if the same section headings appear in the new document as were stored in the default document view. In the instance where the new document is of a type for which a default document view is available, not only the same window structure is created as was present when the user stored the default document view but the same headings within the documents will be positioned within each pane. Such a software feature may be particularly useful to one who often edits documents having the same format. Using an individual who edits a U.S. patent application as an example, the user may set up the window configuration for an initial document to have the abstract within one pane, the background of the invention in another pane and the claims of the patent application in a third pane. Once this default document view is stored, any subsequent patent applications that are retrieved for editing will automatically be configured with these three section headings at the top of the three, independently scrollable panes.

The present invention is usefully employed with wide-screen displays on which a user interface is presented. As used herein, any display with an aspect ratio greater than 4:3 is considered a wide-screen display. The present invention may be particularly useful in combination with screens having aspect ratios of greater than 16:9, and even greater than 2:1. The present invention is improved over the prior art in taking advantage of a wide-screen display while overcoming difficulties inherent in using such a wide-screen display. For example, a large screen enables a greater amount of information to be displayed. If a plurality of windows are employed for a corresponding plurality of applications, then prior-art windowing designs may suffice. If, however, it is desired to employ the wide screen for editing or otherwise interacting with a greater quantity of sequential information within a single application, providing two or more locked presentation sections enables a user to efficiently view and manipulate larger quantities of information in a familiar way. Since many applications are designed to organize information in pages similar to those that can be printed on standard sheets of paper, it is often easiest for a user to interact with the information in page-sized quantities. Hence, enabling displays of multiple pages in an organized and connected way is useful. In particular, providing a flexible capability of associating and disassociating view of related groups of documents in accordance with the present invention can enhance a user's efficiency by reducing the number of control interactions necessary to display and review information. The ability to at least temporarily unlock a particular section allows the ability to independently select and scroll in such unlocked section while not scrolling in an adjacent presentation section, and thereby more easily compare different portions of information.

Moreover, in a large wide-screen display, cursor movements over large areas become tedious. For example if a mouse or track-ball is employed to move a cursor across a wide screen, it must be moved a relatively large distance or the control of the cursor must be made very coarse. Neither approach provides a useful solution. By providing multiple presentation sections as described in the present invention, multiple pages may be viewed and manipulated as a group and the distance required to move the cursor to application control icons may be greatly reduced.

The present invention may also be applied to panoramic information display devices. In particular, the use of the present invention is well adapted to applications requiring a relatively large display for a single user. Displays having a wide aspect ratio or a curved display surface are usefully employed, for example a panoramic computer monitor for desktop use. Panoramic computer monitors may include a display device with a curved rigid screen that is employed together with the present invention as a component within an otherwise conventional desktop computer. In a further embodiment of the present invention, the curved monitor may comprise a panoramic display, that is one that has at least a 16:9 ratio between height and width and subtends at least 45 degrees when viewed at a normal viewing distance.

A variety of technologies may be employed to implement a wide-screen display, with or without a curved screen. In a preferred embodiment, the invention may be employed in a device that includes Organic Light Emitting Diodes (OLEDs) which are composed of small molecule or polymeric OLEDs as disclosed in but not limited to U.S. Pat. No. 4,769,292, issued Sep. 6, 1988 to Tang et al., and U.S. Pat. No. 5,061,569, issued Oct. 29, 1991 to VanSlyke et al. Many combinations and variations of organic light emitting displays can be used to fabricate such a device.

The invention has been described in detail with particular reference to certain preferred embodiments thereof, but it will be understood that variations and modifications can be effected within the spirit and scope of the invention.

### Parts List

10 display
11 wide-screen display
12 display window
12a, 12b, 12c presentation sections
13 controls
14, 14a, 14b panes
15 sequential information
16a, 16b columns
20 vertical scroll bar
21 lock icon
22 horizontal scroll bar
23 unlock icon
30 slider

1. A graphic user interface optimized for the presentation of information from a file on a wide-screen display comprising:
a) a windowed display having at least first and second information presentation sections for concurrently displaying portions of sequential information from the file; and
b) a scroll mechanism associated with each information presentation section, and a locking mechanism for associating one information presentation section with an other information presentation section, wherein when activated, the locking mechanism causes the associated information presentation sections to scroll in common, and when not activated, the locking mechanism allows the associated information sections to scroll independently.

2. The graphic user interface of claim 1, wherein the associated presentation sections are horizontally adjacent.

3. The graphic user interface of claim 1, wherein the state of the locking mechanism is indicated by one or more icons, or by the presence or absence of one or more icons.

4. The graphic user interface of claim 1, wherein when the associated presentation sections are locked, a lock icon is displayed in one presentation section in cooperation with a scroll bar displayed in the other associated presentation section, and when the presentation sections are not locked, a scroll bar is displayed in each presentation section, with or without an unlocked icon

5. The graphic user interface of claim 1, wherein the information presentation sections are displayed within a common window.

6. The graphic user interface of claim 1, wherein the information presentation sections are displayed within separate windows.

7. The graphic user interface of claim 1, wherein the scroll mechanism is represented by one or more horizontal or vertical scroll bar icons.

8. The graphic user interface of claim 1, wherein the first presentation section and the second presentation section display continuous portions of information, display overlapping portions of information, or display discontinuous portions of information.

9. The graphic user interface of claim 1, further comprising tool bar and menu controls and wherein the first and second presentation sections share the same controls.

10. The graphic user interface of claim 1, further comprising separate tool bar and menu controls associated with each of the first and second presentation sections.

11. The graphic user interface of claim 1, further comprising a docking mechanism for contiguously docking two or more information presentation sections in either the horizontal or vertical directions.

12. The graphic user interface of claim 11, wherein docking two or more presentation sections together activates the locking mechanism and causes the docked sections to scroll in common.

13. The graphic user interface of claim 1, wherein the sequential information comprises text information, spreadsheet information, or presentation information, with or without graphic elements.

14. The graphic user interface of claim 1, further comprising a third information presentation section for concurrently displaying portions of sequential information from the file, and wherein the scroll mechanism and locking mechanism allows association of the third presentation section with either or both of the first and second presentation sections.

15. A display system comprising the graphic user interface of claim 1 and a wide-screen display on which the user interface is presented.

16. A software application employing the graphic user interface of claim 1.

17. The software application of claim 1, wherein one or more additional associated presentation sections are created by increasing the window size of one presentation section.

18. The software application of claim 17, wherein the additional presentation sections display contiguous information.
